(19) United States
(12) Patent Application Publication
(10) Pub. No.: US 2026/0118949 A1
(43) Pub. Date: Apr. 30, 2026

(54) Systems and Methods of Deep Reinforcement Learning within an Audiovisual Environment

(71) Applicant: QSC, LLC, Costa Mesa, CA (US)

(72) Inventors: Daniel Allen, Erie, CO (US); Derek Lieb, Boulder, CO (US); Christopher Jaynes, Costa Mesa, CA (US); Matthew Skogmo, Placentia, CA (US)

(21) Appl. No.: 19/368,364

(22) Filed: Oct. 24, 2025

Related U.S. Application Data
(60) Provisional application No. 63/711,872, filed on Oct. 25, 2024.

(51) Int. Cl. G06F 3/01

(52) U.S. Cl. CPC G06F 3/011

(57) ABSTRACT

A computer-implemented system controls peripheral devices using artificial intelligence. Audio or video data captured by one or more microphones or cameras is processed to determine a participant's desire or related contextual information. Based on the determination, one or more peripheral devices are caused to act, such as by presenting related content or control outputs. The system may further note user sentiment regarding the actions taken and update a deep reinforcement learning model, enabling inference of subsequent desires. Sentiment may be derived from the processed audio or video data. In some embodiments, the system presents accompanying or supplemental context, optionally displayed via different portions of a user interface, to improve user interaction and understanding.

### PRIORITY

The present application is a non-provisional of and claims priority to U.S. Provisional Patent Application No. 63/711,872, filed on Oct. 25, 2024, entitled “SYSTEMS AND METHODS OF DEEP REINFORCEMENT LEARNING WITHIN AN AUDIOVISUAL ENVIRONMENT,” having the same inventorship, the disclosure of which is hereby incorporated by reference in its entirety.

### TECHNICAL FIELD

The present disclosure relates to an audiovisual system. In particular, the present disclosure relates to training a deep-reinforcement learning model and using such to validate desires inferred by a large-language model, as part of an audiovisual system.

### BACKGROUND

Audio, video, and control (AVC) systems are typically configured to interconnect, operate, and manage audio systems, video systems, and/or control systems for a particular location, such as a conference room, a classroom, and/or a convention center. AVC system devices may include, but not be limited to, video cameras, microphones (e.g., dynamic beamforming microphones and stationary microphones), speakers, displays and monitors, amplifiers, processing cores, and/or other devices.

### SUMMARY

The present disclosure provides intelligence systems, such as AVC systems, and methods associated with the operation therewith. In some embodiments, the intelligent system may include at least one computing device, a large language model, and one or more of physical devices, any of which may be communicatively coupled to a cloud-computing environment.

In some embodiments, a method, computing system, and computer program product comprise the following: processing audio or video data captured by one or more microphones or cameras; determining, based on the processed data, at least one of a first desire of at least one participant or contextual information associated with the processed data; and causing one or more peripheral devices to act based on the determined desire or contextual information.

In some embodiments, the method, computing system, and computer program product further comprise noting sentiment of the at least one participant regarding the one or more actions taken; updating a deep reinforcement learning model based on the noted sentiment; and inferring at least one second desire of the participant by applying the updated deep reinforcement learning model.

In yet other embodiments, causing the one or more peripheral devices to act comprises presenting accompanying context and supplemental context for the action taken, wherein the contexts are presented via different portions of a user interface to enhance user interaction and system transparency.

Various aspects of the system, as well as other embodiments, objects, features and advantages of this disclosure, will be apparent from the following detailed description of illustrative embodiments thereof, which is to be read in conjunction with the accompanying drawings.

### BRIEF DESCRIPTION OF THE DRAWINGS

FIG. 1 is a block diagram illustrating an overview of devices on which some embodiments of the present technology can operate.

FIG. 2 is a block diagram illustrating an overview of an environment in which some embodiments of the present technology can operate.

FIG. 3 is a block diagram illustrating an overview of an environment in which some embodiments of the present technology can operate.

FIG. 4 is a flow process illustrating an overview of an environment in which some embodiments of the present technology can operate.

FIG. 5 is a block diagram illustrating an overview of an environment in which some embodiments of the present technology can operate.

FIGS. 6A-D are exemplary user interfaces illustrating two sections, according to technical aspects of the present disclosure.

FIG. 7 is a flowchart illustrating a method for generating accompanying context for actions taken by a computing system and presentation of such, according to embodiments of the present disclosure.

FIG. 8 is a flowchart illustrating a method for updating a deep reinforcement learning model to improve inferring desires from a general discussion and environmental data, according to embodiments of the present disclosure.

FIG. 9 is a flowchart illustrating a method for generating and presenting supplemental context and accompanying context within respective portions of a user interface, according to embodiments of the present disclosure.

FIG. 10 is a flowchart illustrating a method for controlling peripheral devices using an artificial intelligence system, according to embodiments of the present disclosure.

### DETAILED DESCRIPTION

Videoconferencing systems play a pivotal role in facilitating communication and collaboration. Whether for business meetings, remote work, or personal interactions, videoconferencing platforms enable real-time conversations across geographical boundaries. These tools allow participants to see and hear each other, share screens, and collaborate on documents. With features like chat, breakout rooms, and virtual backgrounds, videoconferencing has become an integral part of our daily lives, bridging gaps and fostering connections in an increasingly digital landscape. One example of videoconferencing system is an audio, video, and control (AVC) system, for example, that is included in the Seervision and Q-SYS technologies from QSC, LLC.

A video-conferencing system can be configured to manage and control functionality of audio features, video features, and control features. For example, a videoconferencing system can be configured for use with microphones, cameras, amplifiers, and/or controllers. The videoconferencing system can also include a plurality of related features, such as acoustic echo cancellation, audio tone control and filtering, audio dynamic range control, audio/video mixing and routing, audio/video delay synchronization, Public Address paging, video object detection, verification and recognition, multi-media player and a streamer functionality, user control interfaces, scheduling, third-party control, voice-over-IP (VOIP) and Session Initiated Protocol (SIP) functionality, scripting platform functionality, audio and video bridging, public address functionality, other audio and/or video output functionality, etc.

AVC systems, for example, the system disclosed in PCT Application No. PCT/US2024/053076, entitled “Artificial Intelligence Assistance for an Audio, Video and Control System using Room Environment Contextualization and Oral Command Inferencing,” filed on Oct. 25, 2024, naming Lieb et al. as inventors, the disclosure of which is incorporated by reference in its entirety, discuss leveraging a large-language model to supplement conversation (e.g., by providing answers to questions, context to concepts, and so on) and to adjust audio, video, and/or control processing or peripherals to accommodate occupants within, for example, a conferencing room and the like. However, problems inherent with leveraging an LLM include, but are not limited to, instructing peripherals to act without informing the occupants, leading to confusion and, further, the LLM making incorrect inferences of how best to supplement conversation or accommodate occupants.

Technical aspects of the present disclosure solve the above problem by generating a accompanying context (e.g., a rationale for why a particular peripheral device is acting to reduce occupant confusion of peripheral devices acting seemingly on their own accord); the accompanying context may be presented within a user interface. Further, technical aspects observe a particular sentiment within an environment after a device has acted. The particular type of sentiment may be noted and input to a deep reinforcement learning module to increase a probability of an LLM to correctly infer instructions.

Technical aspects of the present disclosure may further include providing a screen separated into two distinct sections. The first section may provide supplemental context and the second screen may provide accompanying context. For example, the first section of the screen may provide a definition to the particular acronym discussed between meeting participants or in response to a participant directly asking the videoconferencing system. The second section May provide accompanying context for actions taken by peripherals that the LLM has inferred to be desired by occupants. For example, if an occupant mentioned that the occupant was too hot and the LLM infers an instruction that the occupant would like to lower the temperature in the room, and a peripheral (e.g., HVAC) lowers the temperature, the LLM may produce accompanying text for presentation within the second section that may state, “Hello, I heard that there was mention that it was hot in here, so I've lowered the temperature to this degree.” However, the occupants may enjoy being hot or may have walked inside the building from being outside where there is a snow blizzard, and the occupants are discussing how warm the inside temperature is compared to outside. In this case, the LLM may infer an incorrect desire to turn down the temperature. However, by presenting within the second section the following, “It seems like everyone is hot. I am going to turn down the temperature,” occupants may verbally respond, “Please do not turn down the temperature.”

In addition to, or alternatively, the second section may not present a justification after a peripheral has acted; rather, the section may present text summarizing a general desire inferred by LLM of occupants and an intention to perform an action. For example, an occupant may say, “Is everybody else hot,” and other occupants may say, “Yes.” Continuing the example, text may be presented within the second section stating, “The heat will be turned down,” or alternatively, “The air conditioner will be turned on.” If occupants protest, no instruction will be sent to the HVAC to lower the temperature in a room.

Technical aspects of the present disclosure further include implementing deep reinforcement learning to improve accuracy of the LLM making inferences. Technical aspects may include observing/monitoring the environment to gauge the sentiment of the LLM's inferences. For example, when there is positive or negative sentiment, such as praise for the air conditioner being turned on, certain facial expressions characteristic of a positive sentiment, or an occupant having to clarify or state the inference was incorrect, each of these sentiments can be used to train a deep reinforcement learning model.

Herein, the terms “desire,” “command,” and “instruction” may be used interchangeably. Likewise, the terms “participant” and “occupant” can be used interchangeably.

Any variety of peripherals may be used in conjunction with the embodiments described herein such as, but not be limited to, video cameras, microphones, speakers, displays and monitors, amplifiers, facility management devices (e.g., space reservation platforms, environmental monitoring platforms), energy management devices (e.g., thermostats, shades, refrigeration controls, etc.), 3^{rd} party platforms (e.g., calendaring plug-ins), sensors, processing cores or other processors, and/or other devices.

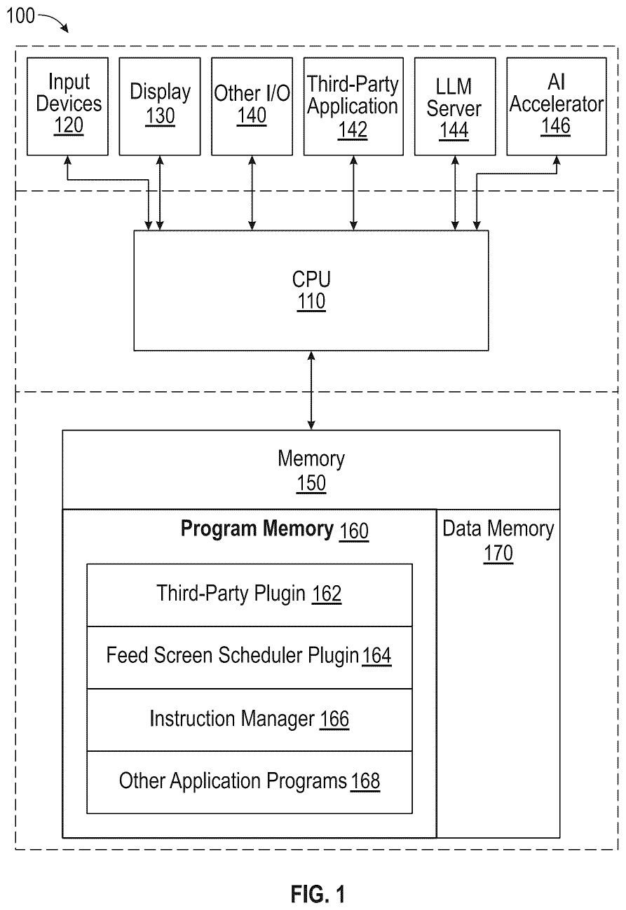

FIG. 1 is a block diagram illustrating an overview of an example of a device 100 on which embodiments of the present technology can operate. In the illustrated embodiment, device 100 includes one or more input devices 120 that provide input to one or more CPU(s) (processor, “the CPU”) 110, notifying it of actions. The actions can be mediated by a hardware controller that interprets the signals received from the input device and communicates the information to the CPU 110 using a communication protocol. Input devices 120 include, for example, a mouse, a keyboard, a touchscreen, an infrared sensor, a touchpad, a wearable input device, a camera- or image-based input device, a microphone, or other suitable user input devices.

The CPU 110 can be a single processing unit or multiple processing units in a device or distributed across multiple devices. CPU 110 can be coupled to other hardware devices, for example, with the use of a bus, such as a PCI bus or PCIe bus. The CPU 110 can communicate with a hardware controller for devices, such as for a display 130. The display 130 can be used to display text and graphics. In some embodiments, the display 130 provides graphical and textual visual feedback to a user, such as the first and second sections, including at least supplemental context and accompanying context, discussed above and throughout the present disclosure.

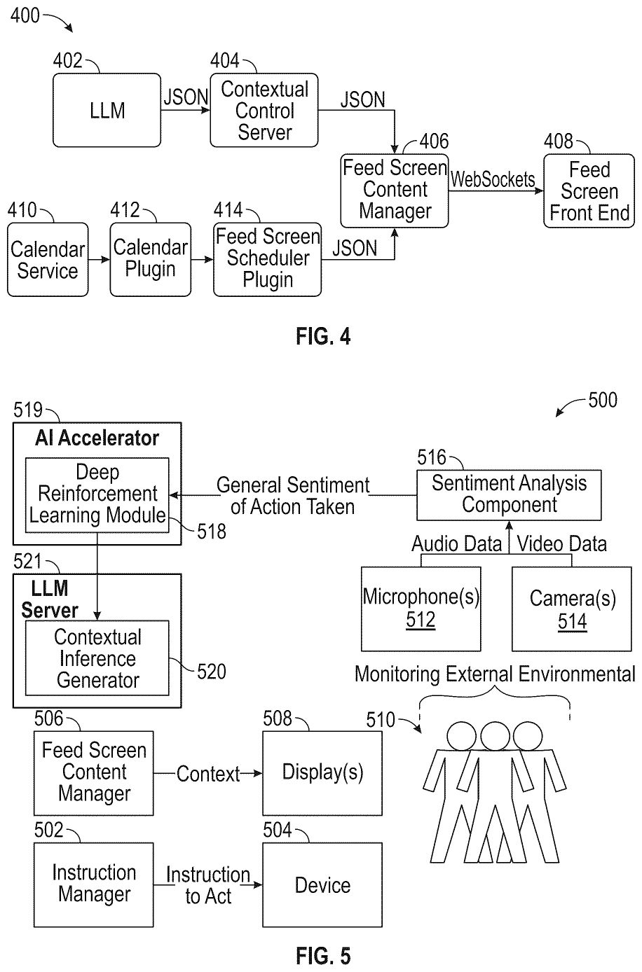

In some embodiments, the display 130 includes the input device as part of the display, such as when the input device is a touchscreen or is equipped with an eye direction monitoring system. In some embodiments, the display is separate from the input device. Examples of display devices include an LCD display screen, an LED display screen, an OLED display screen, an AMOLED display screen, a projected, holographic, or augmented reality display (such as a heads-up display device or a head-mounted device), codec (e.g., encoder, decoder, or both) for decoding IP signals received over an IP network or coding IP signals for transmission over an IP network, and so on. In embodiments, as discussed in more detail below with particular reference to FIG. 4, display 130 may receive content via a web browser; and, additionally/alternatively, a third-party application (e.g., third-party application 142) may run on AI accelerator 146 and may be accessible by any computing device via a web browser. Other I/O devices 140 can also be coupled to the processor; other I/O devices 140 may include a network card, video card, audio card, USB, firewire or other external device, camera, printer, speakers, CD-ROM drive, DVD drive, disk drive, Blu-Ray device, and the like.

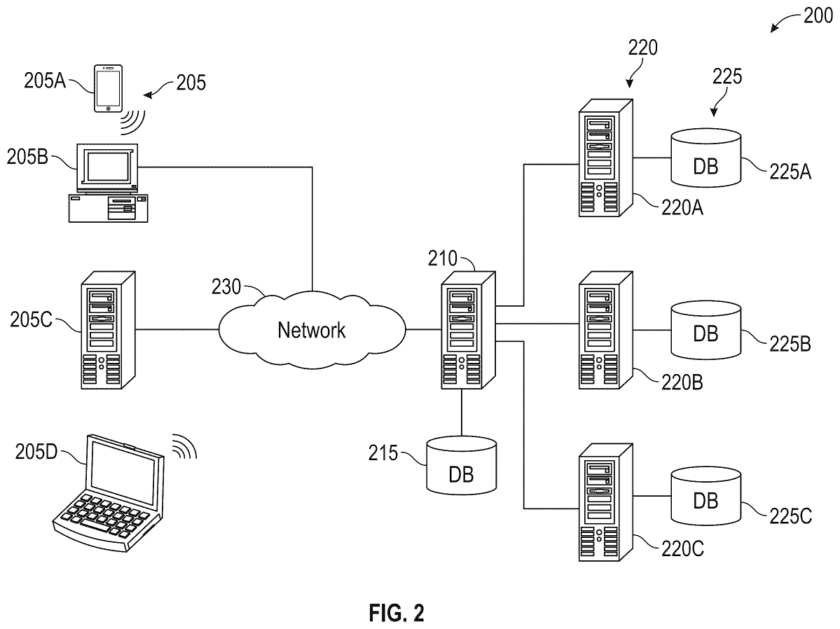

Device 100 further includes software and hardware components, such as third-party application 140 (e.g., Gmail, Outlook, and so on), an LLM server 144, and an AI accelerator 146, as described below with reference to FIGS. 2-5.

In some embodiments, the device 100 also includes a communication device capable of communicating wirelessly or wire-based with a network node. The communication device can communicate with another device or a server through a network using, for example, TCP/IP protocols, a Q-LAN protocol, or others. Device 100 can utilize the communication device to distribute operations across multiple network devices.

The CPU 110 can have access to a memory 150 in a device or distributed across multiple devices. A memory includes one or more of various hardware devices for volatile and non-volatile storage, and can include both read-only and writable memory. For example, a memory can comprise random access memory (RAM), various caches, CPU registers, read-only memory (ROM), and writable non-volatile memory, such as flash memory, hard drives, floppy disks, CDs, DVDs, magnetic storage devices, tape drives, device buffers, and so forth. A memory is not a propagating signal divorced from underlying hardware; a memory is thus non-transitory. Memory 150 can include program memory 160 that stores programs and software, such as a third-party plugin 162, a feed-screen scheduler plugin 164, an instruction manager 166, and other application programs 168. Memory 150 can also include data memory 170 that can store data to be operated on by applications, configuration data, settings, options or preferences, etc., which can be provided to the program memory 160 or any element of the device 100.

Some embodiments can be operational with numerous other computing system environments or configurations. Examples of computing systems, environments, and/or configurations that may be suitable for use with the technology include, but are not limited to, sets of personal computers, loudspeakers, AVC I/O systems, AI accelerators, large-language model servers, semantic and syntactic analysis devices, computing devices configured to execute compute-intensive machine-learning models, networked AVC peripherals (e.g., IP camera(s), IP microphone(s), IP speaker(s), IP touch-screen controllers, and so on, as well as the same but not of an IP-based nature), server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

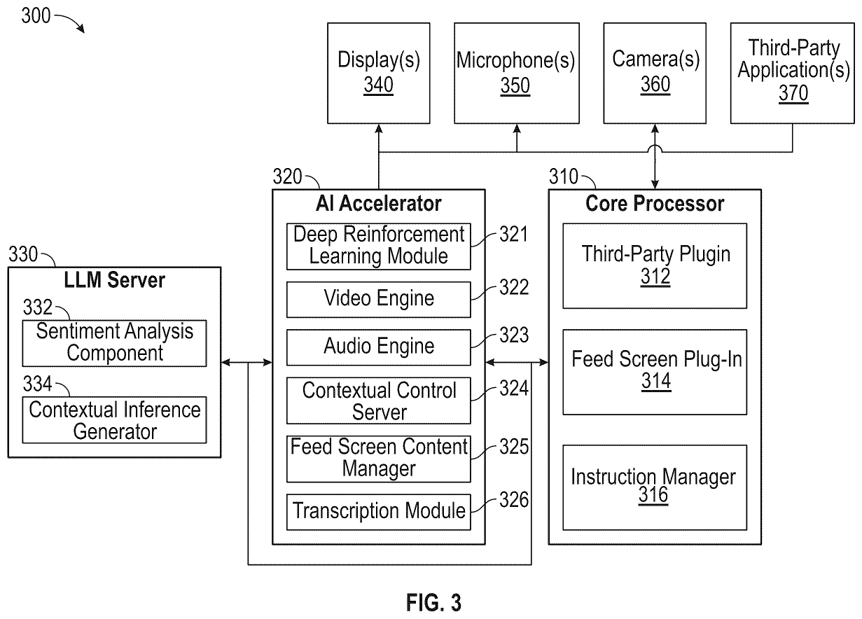

FIG. 2 is a block diagram illustrating an overview of an environment in which embodiments of the present technology can operate. Environment 200 can include one or more client computing devices 205A-D, examples of which can include the device 200 of FIG. 2. In the illustrated embodiment, device 205A is a wireless smartphone or tablet, device 205B is a desktop computer, device 205C is a computer system, and device 205D is a wireless laptop. These are only examples of some of the devices, and other embodiments can include other computing devices. For example, device 205C can be a server (e.g., AI accelerator, an LLM server, and so on, as discussed in more detail with reference to FIGS. 3, 4, and 5) with an Operating System (OS) implementing compute-intensive machine-learning models. For example, device 205C can be a server running a large-language model. Additionally, or alternatively, the client computing devices 205 can operate in a networked environment using logical connections through network 230 to one or more remote computers, such as a server computing device 210 to provide these services.

In some embodiments, the server computing device 210 is an edge server which receives client requests and coordinates the fulfillment of those requests through other servers, such as first-third server computing devices 220A-C (sometimes referred to collectively as “server computing devices 220”). Server computing devices 210 and 220 (or computing devices 205A-C) can comprise computing systems, such as the computing device discussed in more detail below with reference to FIG. 3 and/or the device 100 of FIG. 1. Though each server computing device 110 and 120 is displayed logically as a single server, server computing devices can each be a distributed computing environment encompassing multiple computing devices located at the same or at geographically disparate physical locations. In some embodiments, each of the server computing devices 120 corresponds to a group of servers.

Client computing devices 205 and server computing devices 210 and 220 can each function as a server or client to other server/client devices. The server computing device 210 can connect to a database 215. The first-third server computing devices 220A-C can each connect to a corresponding one of first-third databases 225A-C (sometimes referred to collectively as “databases 225”). As discussed above, each of the server computing devices 220 can correspond to a group of servers, and each of these servers can share a database or can have their own database. Databases 215 and 225 can warehouse (e.g., store) information. Though databases 215 and 225 are displayed logically as single units, databases 215 and 225 can each be a distributed computing environment encompassing multiple computing devices, can be located within their corresponding server, or can be located at the same or at geographically disparate physical locations.

Network 230 can be a local area network (LAN) or a wide area network (WAN), but can also be other wired or wireless networks. In some embodiments, portions of network 230 can be a LAN or WAN implementing a relevant communication protocol. Portions of network 230 may be the Internet or some other public or private network. Client computing devices 205 can be connected to network 230 through a network interface, such as by wired or wireless communication. While the connections between server computing device 210 and the server computing devices 220 are shown as separate connections, these connections can be any kind of local, wide area, wired, or wireless network, including network 230 or a separate public or private network.

FIG. 3 is a block diagram illustrating an overview of an environment in which embodiments of the present technology can operate. Environment 300 includes a core processor 310, an AI accelerator 320, an LLM server 330, a display 340, at least one microphone 350, at least one camera 360, and at least one third-party application 370.

According to technical aspects of the present disclosure, core processor 310, AI accelerator 320, LLM server 330 may all be located in a same or different physical compute environments and/or within a cloud computing environments. For example, AI accelerator 320 and LLM server 330 may be co-located within a physical compute environment proximate to core processor 310. As another example, AI accelerator 320 may be co-located within a physical compute environment proximate to processing core 310 while LLM server 330 is remotely located within a cloud computing environment. As yet another example, each of core processor 310, AI accelerator 320, LLM server 330 may all be located within a same or different cloud computing environments.

Core processor 310 can manage and process audio, video, and control signals received from any of, for example, display 340 (e.g., display 130), microphone 350, camera 360, and third-party application 370 in real-time. Core processor 310 includes at least a third-party plugin 312, a feed-screen scheduler plugin 314, and an instruction manager 316. Third-party plugin 312 may correspond to a third-party application (e.g., third-party application 370), include a calendaring plug-in (e.g., calendar plug-in with reference to FIG. 4), and configure the operating system running on core processor 310 to perform specific features or functions. Feed-screen plug-in 314 may format any content generated by third-party plugin 312 in a particular fashion presentable for viewing within a user interface, for example, of display 340. Instruction manager 316 may receive instructions inferred by contextual inference generator 334, determine which corresponding peripheral device (e.g., camera 360, smart shades, an HVAC system, and the like) the instructions are destined for, and transmit the instructions to the peripheral device.

AI accelerator 320 may comprise a specialized hardware component or system designed to increase the efficacy of computational processes required for artificial-intelligence tasks, particularly those relating to machine learning or deep-reinforcement learning. For example, AI accelerator 320 may comprise any of graphics processing units to ingest and process video data, tensor processing units for processing deep-learning task and large-scale neural network computations for processing audio data, field-programmable gate arrays, application-specific integrated circuits to accelerate neural network operations, and neural processing units dedicated to processing image and video data and natural language processing. Artificial intelligence tasks (such as neural networks and the like) require complex calculations that are computationally intensive. AI accelerator 320 may be able to manage these types of tasks more efficiently than core processor 310. AI accelerator 320 includes a deep reinforcement learning module 321, a video engine 322, an audio engine 323, a feed-screen content manager 325, a contextual control server 324, and a transcription module 326.

Deep reinforcement learning module 321 may comprise a deep-reinforcement learning model that is trained on audio and video data, collected by microphone 350 and camera 360, respectively, inferred commands and general sentiments to those commands when executed, and so on. Deep reinforcement learning module 321 may be updated based on general sentiment (e.g., by participants) when actions are taken by peripheral devices, as discussed throughout. For example, deep reinforcement learning module 321 may receive commands inferred from conversation from contextual inference generator 334, that is input to a deep reinforcement learning model. The model may be updated when deep reinforcement learning module 321 receives general sentiment from sentiment analysis component 332 of participants after a command is executed, noting whether or not the command was correctly inferred by contextual inference generator 334. This updated model may be used to improve LLM server and any module therein that predicts desires of participants.

Video engine 322 may comprise a specialized software or hardware component designed to automatically process, analyze, and manage video data captured by camera 360 and received by AI accelerator 320. Video engine 322 may perform various AI tasks, such as real-time video analysis, object detection, object recognition and classification, object grouping, object framing, motion tracking, content recognition, and so on.

Audio engine 323 may comprise a specialized software or hardware component designed to automatically process, analyze, and manage audio captured by microphone 350 and is received by AI accelerator 320. Audio engine 323 may perform various tasks on the captured audio data such as speech recognition, sound classification, blind-source separation (e.g., separating audio signals of different talkers, separating audio signals of noise from audio signals of talkers, and so on), voice activity detection, audio event detection and classification, and so on.

Contextual control server 324 may facilitate data transmission from a contextual inference generator 334 to feed-screen content manager 325 in a particular format (e.g., over an HTTP request in JSON format). Feed-screen content manager 325 may discern between several types of data generated by contextual inference generator 334 (e.g., an inferred instruction, supplemental context, accompanying context, and so on, as discussed herein) and received by contextual control server 324. Feed-screen content manager 325 may further determine a position for each type of discerned data for presentation within a user interface of, for example, display 340. Transcription module 326 may receive audio data processed and analyzed by audio engine 323 and transcribe any speech comprised within the audio data. Further, transcription module 326 may transcribe certain types of noises such as non-speech sounds: laughter, sighs, yawning, door slams, wind blowing, engine noises, alarms, and so on, to provide LLM server with a more detailed transcription that LLM server can then draw more robust contextual information from.

LLM server 330 may comprise a server that hosts and serves a large-language model such as a generative pre-trained transformer (GPT) bidirectional encoder representations from transformers (BERT), or similar AI model. LLM server 330 may process text-based inference requests (e.g., transcriptions provided by transcription module 326), direct requests, and the like, and provide a service generated by the model such as a prediction, supplemental context, accompanying context, response to a request, or an inferred command or instruction for a device to perform consistent with a desire of, for example, at least one participant within a conference room.

Contextual inference generator 334 may comprise a system or model that uses artificial intelligence to generate contextually relevant responses, supplemental context, accompanying context, predictions, or conclusions based on received data, such as text generated by transcription module 326, processed video data or image data from video engine 232, and processed audio data from audio engine 232. Contextual inference generator 334 can analyze and process the received data to determine a surrounding context, including understanding participant's intent, relationships between participants, participant historical data, and so on, all within a broader environment, such as captured audio and video data, including non-speech sounds: alarms, coughing, yawning, and so on. Once the context is understood, contextual inference generator 334 can then infer an instruction, supplemental context, respond to a request, as well as generate an accompanying context to the inferred command for presentation within display 340.

Likewise, sentiment analysis component 332 may perform substantially the same analysis as contextual inference generator 334 to determine context; however, rather than inferring an instruction, generating supplemental context and/or accompanying context, responding to a request, and so on, sentiment analysis component 332 may infer a sentiment of participants in response to a device executing an inferred command to determine whether there is a positive or negative sentiment. The inferred sentiment may then be sent to deep-reinforcement learning module 321 for updating the model (e.g., a neural network and the like), as discussed above. Either or both of sentiment analysis component 332 and contextual inference generator 334 may rely on deep reinforcement learning module 321 for more accurate results.

In one non-limiting example, core processor 310 may receive audio and/or video data captured from microphone 350 or camera 360, respectively. Core processor 310 may send captured audio and video data to audio engine 323 and video engine 322, respectively, for processing. Audio engine 323 may process the audio data so that the audio data is correctly formatted for transcription module 336 to transcribe the speech and any related audio data (e.g., sounds that lend support to any spoken words, such as ‘uh huh’ in response to a talker saying ‘the temperature is too hot’). Audio engine 323 may include one or more machine learning models, such as blind source separation, and the like, that can separate speech from noise so that the speech can be clearly identified within the captured audio data.

Video engine 322 may provide additional context surrounding the captured audio data. For example, video engine 323 may identify and classify a participant's facial expression in response to a participant saying that ‘the temperature is too hot,’ that may lend support or dissent to a general opinion of other participants within the room with regard to the participant's comment.

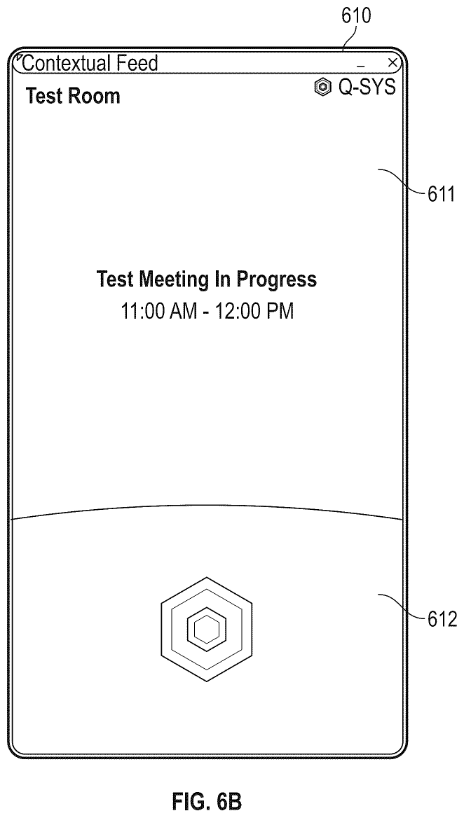

Transcription module 326 may transcribe the audio data and include any additional comments or expressions noted by either of audio engine 322 or video engine 323. Contextual inference generator 334 may receive the transcribed text from transcription module 336 and infer at least one command and accompanying context. In embodiments, in addition to, or alternatively, contextual inference generator 334 may determine supplemental context should be provided to room participants because the discussion lacks relevant context. In embodiments, in addition to, or alternatively, contextual inference generator 334 may identify a direct command within the transcription a participant would like performed and generate an instruction destined for instruction manager 316 to send to the corresponding peripheral device. In other embodiments, contextual inference generator 334 may generate contextual information related to audio or video input. For example, if a participant says, “Did you see the Grizzlies game last night?”, the contextual inference generator 334 automatically retrieves and presents the game's score or related information via a display or another peripheral device connected to the network. Contextual control server 324 may receive the at least one inferred command from contextual inference generator 334 and determine which peripheral devices the command applies to. Further, if there is supplemental context and/or accompanying context, feed-screen content manager 334 may determine a position of where either or both context should be presented within a user interface of display 340, for example, the first and second sections as discussed with reference to FIGS. 6A-D.

AI accelerator 320 may send the command to the particular peripheral device (e.g., smart shades within a conferencing room) so that the peripheral device executes the command. AI accelerator 320 may also send either or both of supplemental context and accompanying context, as well as their relative positions within a user interface, to display 340 for presentation. For example, as discussed throughout, display 340 may present two sections within a user interface: the first section presenting the supplemental context and the second section presenting the accompanying context.

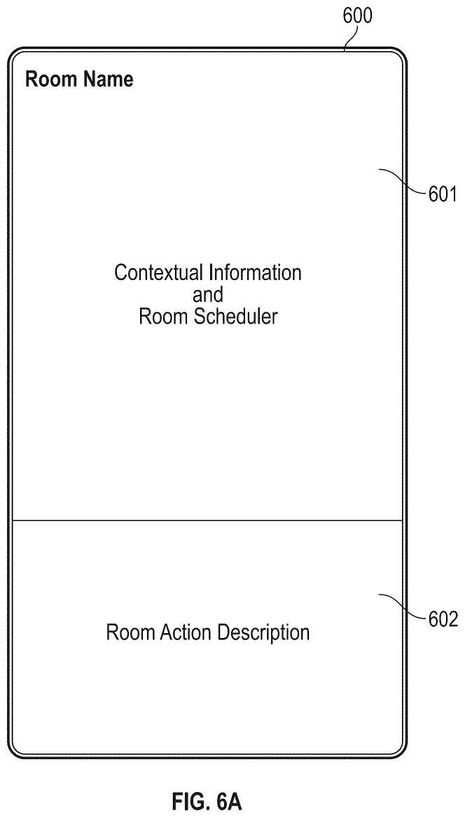

Microphone 350 and camera 360 may then capture additional audio and video data, respectively, and send the captured data through a substantially similar data path: to respective audio and video engines 322, 323, to transcription module 336 (optionally), and then to a sentiment analysis component 332. Sentiment analysis component 332 can determine whether there is a positive or negative sentiment from participants in response to the command executed by the peripheral device. For example, sentiment analysis component 332 may determine from classified facial expressions (e.g., happy, sad, mad, etc.), and inference of transcribed text by contextual inference generator 334, that the sentiment of participants is generally positive. The positive sentiment, that the action taken was a correct action based on a correctly inferred command, may be sent to deep reinforcement learning module 321 for updating a model, as discussed in more detail above and with reference FIG. 5.

Each of core processor 310, AI accelerator 320, LLM server 330, display 340, microphone 350, and camera 360 may communicate via a point-to-point communications (e.g., HDMI, USB, UVC, and so on), over a network protocol (e.g., Transmission Control Protocol/Internet Protocol, Wi-Fi, and the like), or some combination. In embodiments, any of core processor 310, AI accelerator 320, LLM server 330, or any components within core processor 310, AI accelerator 320, LLM server 330 may be hosted on-premises, within a cloud computing environment, or some combination thereof.

FIG. 4 is a flow diagram illustrating an overview of a process in which some embodiments of the present technology can operate. Flow diagram 400 may include LLM server (e.g., LLM server 330) inferring (402) an instruction that the LLM has inferred from a conversation between participants or a comment made by a participant, as discussed throughout. LLM server may further generate either or both of supplemental context (e.g., text asking whether the participants would like an action performed, an answer to a question by a participant, context to supplement a conversation in response to a talker requesting financial data of a particular product or to correct an mistake in the conversation, etc.) and accompanying context (e.g., a rationale or justification for inferring the particular instruction that may provide context to participants within, for example a conferencing room, for devices executing the inferred instruction).

LLM server may provide either or both of the supplemental context and accompanying context to contextual control server (e.g., contextual control server 335). According to some technical aspects, LLM server may output the supplemental context and accompanying context in a JSON format.

Flow diagram 400 may further include contextual control server (e.g., contextual control server 335) receiving (404) the supplemental context and accompanying context, and route either or both to a feed-screen content manager (e.g., feed-screen content manager 334) over an HTTP request in JSON format. In embodiments, feed-screen content manager is running on an AI accelerator (e.g., AI accelerator 320) separate from the contextual control server. Feed-screen content manager may discern (406) between each type of context received and may further determine a position for each type of context for presentation within a user interface (e.g., as shown with supplemental context in first section 621 and accompanying context in second section 632) for example, as discussed below with reference to FIGS. 6A-D. Feed-screen content manager may send via WebSocket either or both content to feed-screen front end for service (408) of the two types of contextual information over a dynamic webpage.

Flow diagram 400 may further include a third-party application (e.g., third-party application 370), such as a calendar service (e.g., Outlook, Gmail, etc.), providing (410) calendaring information of one or more accounts, e.g., within an organization or who are scheduled to occupy a particular space, to a calendar plug-in installed within an operating system (e.g., Q-SYS operating system and the like) running on a core processor (e.g., core processor 310). Calendar plug-in (e.g., third-party plug-in 312) may receive and process (412) the calendaring information before sending the calendaring information to feed-screen scheduler plug-in (e.g., feed-screen scheduler plug-in). Feed-screen scheduler plug-in may format (414) the calendaring information in a desirable way for presentation within a user interface (e.g., as shown within firsts section 612, 611) of a front end display (e.g., display 130, 340), then send the formatted calendaring information via JSON format to feed-screen content manager for sending via WebSocket to the front end display (e.g., display 130, 340).

FIG. 5 is a block diagram illustrating an overview of an environment in which embodiments of the present technology can operate. Environment 500 includes an instruction manager 502, device 504, a feed screen content manager 506, and at least one display 508. Further, environment 500 includes at least one participant 510, at least one microphone 512, at least one camera 514, a sentiment analysis component 516, a deep reinforcement learning module 518, and a contextual inference generator 520. Each of the components 502, 506, 512, 514, 516, 518, 519, 520, and 521 may perform substantially similar operations as components described in FIGS. 3:316, 325, 340, 350, 360, 332, 321, 320, 334, and 330, respectively.

According to technical aspects of the present disclosure, in a non-limiting example, instruction manager 502 (e.g., running on a core processor, such a core processor 310) may send device 504 (e.g., smart HVAC, smart shades/blinds, smart lights, and any other device that a person of ordinary skill in the art would recognize as a device designed to execute instructions and that can be communicably coupled to a core processor and/or AI accelerator) instructions to perform an action, as described herein. Further, feed-screen content manager 506 may transmit content for presentation within respective sections of display 508; the content may include supplemental context, accompanying context, calendaring information, and so on, as discussed with reference to FIGS. 3, 4, and 6A-6D.

Microphone(s) 512 and camera(s) 514 may monitor the external environment including participant(s) 510 to capture their general sentiment of the action taken by device 504; the general sentiment captured in the form of audio and video data. Captured audio and video data may be sent to sentiment analysis component 516 for processing and analyzing (as discussed above with reference to at least FIG. 3) to determine whether the general sentiment may be classified as positive or negative. That classification may be transmitted to deep reinforcement learning module 518, along with a short description of the action taken by device 504, and a description of how contextual inference generator 334 analyzed a transcription (e.g., generated by transcription module 326) and any accompanying video and audio data (e.g., processed and analyzed by video and audio engines 322, 323, respectively) to infer a command, so that deep reinforcement learning module 518 may update the deep-learning model. This information may be passed along to contextual inference generator 520 for increasing the accuracy of inferences made by contextual inference generator 520.

FIGS. 6A-D are exemplary user interfaces illustrating at least two sections and their corresponding content, according to technical aspects of the present disclosure. Referring to FIG. 6A, user interface 600 (e.g., within a display, such as any display 130, 340, or 508) may be partitioned into two sections: a first section 601 may present supplemental context and/or content relating to a third-party application, e.g., calendaring information relating to a scheduled meeting received from calendar service (such as calendar service 410); and a second section 602 that includes accompanying context to clarify actions performed by peripheral devices. In embodiments, accompanying context within the second section may include a description of an action taken by a peripheral device, a justification or rationale for an action of the peripheral device, and/or any other description of how or why the peripheral device has changed from one particular state to another.

In embodiments, user interface 600 may comprise any number of sections (e.g., 1, 2, 3, 4, and so on). For example, there may be only a single section when there is no accompanying context such as when a command has not been executed by a device. Alternatively, as shown in FIG. 6B, user interface 610 includes two sections: a first section 611 that includes graphics in the top portion of the section and calendaring information stating, “Test Meeting In Progress” and the respective time of the test meeting. A second section 612 includes a graphics without any text, for example, because a device has not acted and no command has been inferred.

As shown in FIG. 6C, user interface 620 comprising two sections: a first section 621 presenting supplementary context, for example, in response to a participant asking the question, “What does OKR stand for?” or in response to general confusion among participants to the meaning of “OKR.” A second section 622 is substantially similar to second section 612 of FIG. 6B.

In FIG. 6D, a user interface 630 comprises a first section 631 that is substantially similar to first section 611. However, a second section 632 of user interface 630 presents accompanying context: text justifying an action taken by a device (e.g., shades). In second section, contextual inference generator 334 may have inferred a command to closing window shades from general conversation between participants about the glare in the room from the sun.

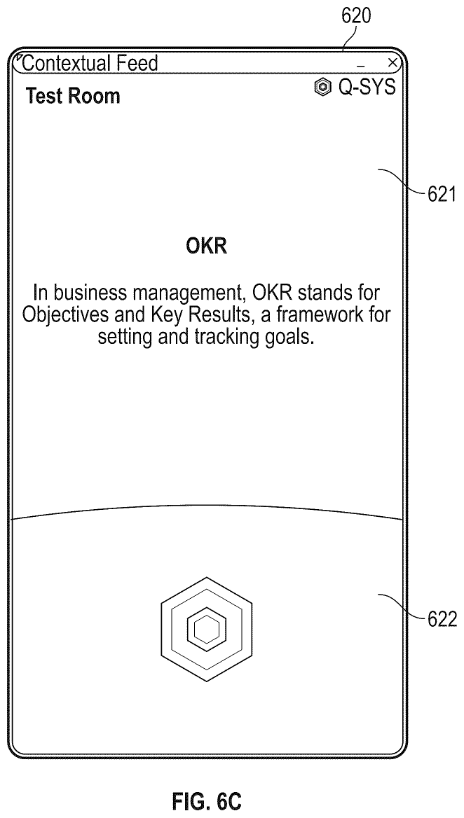

FIG. 7 is a flowchart illustrating a method for generating accompanying context for actions taken by a computing system and presentation and deep-reinforcement learning of such, according to technical aspects of the present disclosure. Method 700 may include capturing (702) audio and/or video data by a first set of peripheral devices. In one example of block 700, a camera and/or a microphone may capture audio and video data of an external environment. Method 700 may further include inferring (704) at least one desire of at least one participant based on processing the captured audio and video data.

Method 700 may further include acting (706) based on the inferred at least one desire. In an example of block 704, a processing core may send an instruction for shades, that are communicatively coupled to core, to lower. Method 700 may further include presenting (708) accompanying context for the action taken. In an example of block 708, a processing core or an AI accelerator may transmit a generated accompanying context for the action taken for presentation within a user interface.

Method 700 may further include optional blocks 710 and 712. Method 700 may further include noting (710) the sentiment of the action taken. In an example of block 710, peripheral devices may capture audio and video data of the external environment that a participant sentiment analysis component may process to determine the sentiment of participants responsive to the action taken. Method 700 may further include updating (712) a deep-reinforcement model based on the determined sentiment.

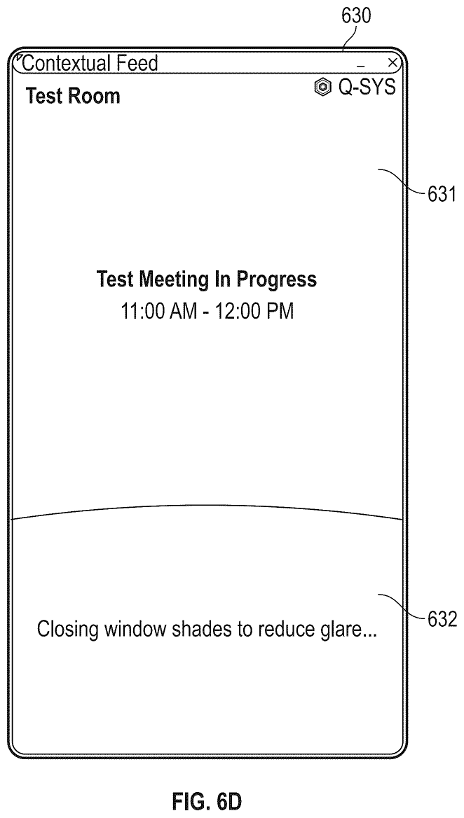

FIG. 8 is a flowchart illustrating a method for updating a deep reinforcement learning model to improve inferring desires from a discussion and from monitoring an environment, according to technical aspects of the present disclosure. Method 800 includes causing (802) at least one device to act based on inferring a first set of desires. Method 800 further includes monitoring (804) an environment where the at least one peripheral device acted. Method 800 includes noting (806) a sentiment within the environment of the action taken. Method 800 further includes updating (808) a deep reinforcement learning model based on the noted sentiment. Method 800 includes inferring (810) as second set of desires based on applying the updated deep reinforcement learning model.

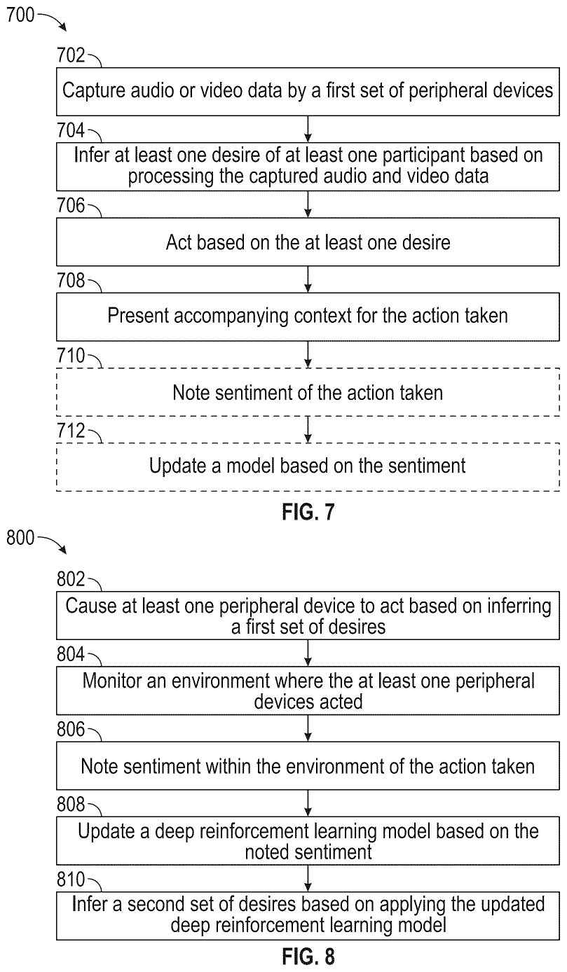

FIG. 9 is a flowchart illustrating a method for generating and presenting supplemental context and accompanying context within respective portions of a user interface, according to embodiments of the present disclosure. Method 900 may include capturing (902) audio and/or video data by a first set of peripheral devices. Method 900 may further include inferring (904) at least one desire of at least one participant based on processing the captured audio and video data. Method 900 may further include acting (906) based on the inferred at least one desire. Method 900 may further include presenting (908) supplemental context and accompanying context for the action taken within respective portions of a user interface.

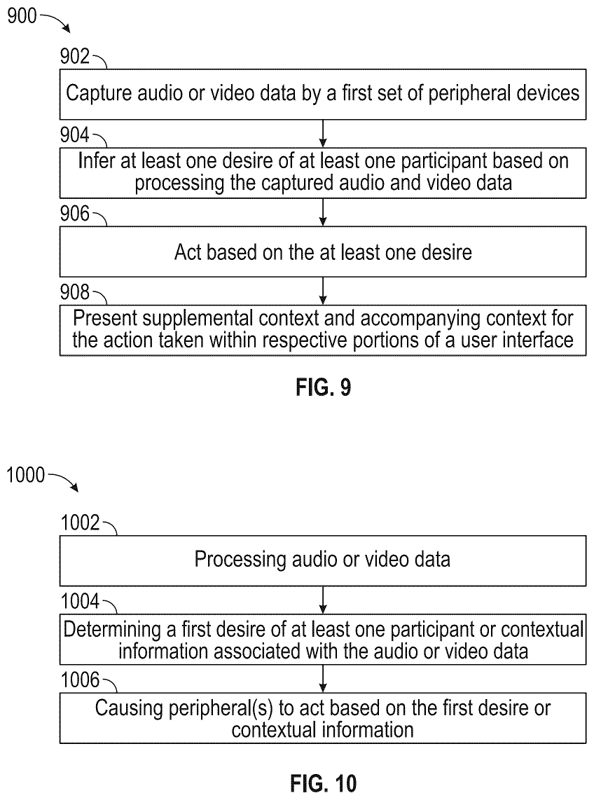

FIG. 10 is a flowchart illustrating a method for controlling peripheral devices using an artificial intelligence system, according to embodiments of the present disclosure. Method 1000 may include processing (1002) audio and/or video data captured by one or more microphones or one or more cameras. Method 1000 may further include determining (1004) a first desire of at least one participant or contextual information associated with the audio or video data. Method 1000 may further include causing (1006) one or more peripherals to act based on the first desire or contextual information.

From the foregoing, it will be appreciated that specific embodiments of the technology have been described herein for purposes of illustration, but well-known structures and functions have not been shown or described in detail to avoid unnecessarily obscuring the description of the embodiments of the technology. To the extent any material incorporated herein by reference conflicts with the present disclosure, the present disclosure controls. Where the context permits, singular or plural terms may also include the plural or singular term, respectively. Moreover, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. Furthermore, as used herein, the phrase “and/or” as in “A and/or B” refers to A alone, B alone, and both A and B. Additionally, the terms “comprising,” “including,” “having,” and “with” are used throughout to mean including at least the recited feature(s) such that any greater number of the same features and/or additional types of other features are not precluded. Further, the terms “approximately” and “about” are used herein to mean within at least within 10% of a given value or limit. Purely by way of example, an approximate ratio means within 10% of the given ratio.

Several implementations of the disclosed technology are described above in reference to the figures. The computing devices on which the described technology may be implemented can include one or more central processing units, memory, input devices (e.g., keyboard and pointing devices), output devices (e.g., display devices), storage devices (e.g., disk drives), and network devices (e.g., network interfaces). The memory and storage devices are computer-readable storage media that can store instructions that implement at least portions of the described technology. In addition, the data structures and message structures can be stored or transmitted via a data transmission medium, such as a signal on a communications link. Various communications links can be used, such as the Internet, a local area network, a wide area network, or a point-to-point dial-up connection. Thus, computer-readable media can comprise computer-readable storage media (e.g., “non-transitory” media) and computer-readable transmission media.

Methods and embodiments described herein further relate to any one or more of the following paragraphs:
1. A computer-implemented method for controlling peripheral devices using an artificial intelligence system, the method comprising: processing audio or video data captured by one or more microphones or one or more cameras; determining, based on the processed audio data or video data, at least one of: a first desire of at least one participant; or contextual information associated with the processed audio data or video data; and causing one or more peripheral devices to act based on the first desire or information.
2. The computer-implemented method as defined in paragraph 1, further comprising: noting sentiment of the at least one participant of the one or more actions taken; and updating a deep reinforcement learning model with the noted sentiment.
3. The computer-implemented method as defined in paragraphs 1 or 2, further comprising inferring at least one second desire based on applying the updated deep reinforcement learning model.
4. The computer-implemented method as defined in any of paragraphs 1-3, wherein audio data or video data is processed to determine the noted sentiment.
5. The computer-implemented method as defined in any of paragraphs 1-4, wherein causing the one or more peripheral devices to act comprises presenting, via the one or more peripheral devices, accompanying context for causing the one or more peripheral devices to act.
6. The computer-implemented method as defined in any of paragraphs 1-5, wherein causing the one or more peripheral devices to act comprises presenting, via the one or more peripheral devices, supplemental context, wherein the supplemental context is different from an accompanying context for causing the peripheral devices to act.
7. The computer-implemented method as defined in any of paragraphs 1-6, wherein causing the one or more peripheral devices to act comprises presenting supplemental context and accompanying context for the one or more actions taken via different portions of a user interface.
8. A system for controlling peripheral devices using an artificial intelligence system, the method comprising: one or more microphones or one or more cameras; and processing circuitry configured to perform operations comprising: processing audio or video data captured by the one or more microphones or the one or more cameras; determining, based on the processed audio data or video data, at least one of: a first desire of at least one participant; or contextual information associated with the processed audio data or video data; and causing one or more peripheral devices to act based on the first desire or information.
9. The system as defined in paragraph 8, further comprising: noting sentiment of the at least one participant of the one or more actions taken; and updating a deep reinforcement learning model with the noted sentiment.
10. The system as defined in paragraphs 8 or 9, further comprising inferring at least one second desire based on applying the updated deep reinforcement learning model.
11. The system as defined in any of paragraphs 8-10, wherein audio data or video data is processed to determine the noted sentiment.
12. The system as defined in any of paragraphs 8-11, wherein causing the one or more peripheral devices to act comprises presenting, via the one or more peripheral devices, accompanying context for causing the one or more peripheral devices to act.
13. The system as defined in any of paragraphs 8-12, wherein causing the one or more peripheral devices to act comprises presenting, via the one or more peripheral devices, supplemental context, wherein the supplemental context is different from an accompanying context for causing the peripheral devices to act.
14. The system as defined in any of paragraphs 8-13, wherein causing the one or more peripheral devices to act comprises presenting supplemental context and accompanying context for the one or more actions taken via different portions of a user interface.

Moreover, the methods described herein may be embodied within a non-transitory computer-readable medium comprising instructions which, when executed by the processor/processing circuitry, causes the processor to perform any of the methods described herein

From the foregoing, it will also be appreciated that various modifications may be made without deviating from the disclosure or the technology. For example, one of ordinary skill in the art will understand that various components of the technology can be further divided into subcomponents, or that various components and functions of the technology may be combined and integrated. In addition, certain aspects of the technology described in the context of particular embodiments may also be combined or eliminated in other embodiments.

Although various embodiments and methods have been shown and described, the disclosure is not limited to such embodiments and methods and will be understood to include all modifications and variations as would be apparent to one skilled in the art. Therefore, it should be understood that the disclosure is not intended to be limited to the particular forms disclosed. Rather, the intention is to cover all modifications, equivalents and alternatives falling within the spirit and scope of the disclosure as defined by the appended claims.

What is claimed is:

1. A computer-implemented method for controlling peripheral devices using an artificial intelligence system, the method comprising:
processing audio or video data captured by one or more microphones or one or more cameras;
determining, based on the processed audio data or video data, at least one of:
a first desire of at least one participant; or
contextual information associated with the processed audio data or video data; and
causing one or more peripheral devices to act based on the first desire or information.

2. The computer-implemented method as defined in claim 1, further comprising:
noting sentiment of the at least one participant of the one or more actions taken; and
updating a deep reinforcement learning model with the noted sentiment.

3. The computer-implemented method as defined in claim 2, further comprising inferring at least one second desire based on applying the updated deep reinforcement learning model.

4. The computer-implemented method as defined in claim 2, wherein audio data or video data is processed to determine the noted sentiment.

5. The computer-implemented method as defined in claim 1, wherein causing the one or more peripheral devices to act comprises presenting, via the one or more peripheral devices, accompanying context for causing the one or more peripheral devices to act.

6. The computer-implemented method as defined in claim 1, wherein causing the one or more peripheral devices to act comprises presenting, via the one or more peripheral devices, supplemental context, wherein the supplemental context is different from an accompanying context for causing the peripheral devices to act.

7. The computer-implemented method as defined in claim 1, wherein causing the one or more peripheral devices to act comprises presenting supplemental context and accompanying context for the one or more actions taken via different portions of a user interface.

8. A system for controlling peripheral devices using an artificial intelligence system, the method comprising:
one or more microphones or one or more cameras; and
processing circuitry configured to perform operations comprising:
processing audio or video data captured by the one or more microphones or the one or more cameras;
determining, based on the processed audio data or video data, at least one of:
a first desire of at least one participant; or
contextual information associated with the processed audio data or video data; and
causing one or more peripheral devices to act based on the first desire or information.

9. The system as defined in claim 8, further comprising:
noting sentiment of the at least one participant of the one or more actions taken; and
updating a deep reinforcement learning model with the noted sentiment.

10. The system as defined in claim 9, further comprising inferring at least one second desire based on applying the updated deep reinforcement learning model.

11. The system as defined in claim 9, wherein audio data or video data is processed to determine the noted sentiment.

12. The system as defined in claim 8, wherein causing the one or more peripheral devices to act comprises presenting, via the one or more peripheral devices, accompanying context for causing the one or more peripheral devices to act.

13. The system as defined in claim 8, wherein causing the one or more peripheral devices to act comprises presenting, via the one or more peripheral devices, supplemental context, wherein the supplemental context is different from an accompanying context for causing the peripheral devices to act.

14. The system as defined in claim 8, wherein causing the one or more peripheral devices to act comprises presenting supplemental context and accompanying context for the one or more actions taken via different portions of a user interface.

15. A non-transitory computer-readable storage medium storing instructions that, when executed by a computing system, cause the computing system to perform operations comprising:
processing audio or video data captured by one or more microphones or one or more cameras;
determining, based on the processed audio data or video data, at least one of:
a first desire of at least one participant; or
contextual information associated with the processed audio data or video data; and
causing one or more peripheral devices to act based on the first desire or information.

16. The computer-readable storage medium as defined in claim 15, further comprising:
noting sentiment of the at least one participant of the one or more actions taken; and
updating a deep reinforcement learning model with the noted sentiment.

17. The computer-readable storage medium as defined in claim 16, further comprising inferring at least one second desire based on applying the updated deep reinforcement learning model.

18. The computer-readable storage medium as defined in claim 16, wherein audio data or video data is processed to determine the noted sentiment.

19. The computer-readable storage medium as defined in claim 15, wherein causing the one or more peripheral devices to act comprises presenting, via the one or more peripheral devices, accompanying context for causing the one or more peripheral devices to act.

20. The computer-readable storage medium as defined in claim 15, wherein causing the one or more peripheral devices to act comprises:
presenting, via the one or more peripheral devices, supplemental context, wherein the supplemental context is different from an accompanying context for causing the peripheral devices to act; or
presenting supplemental context and accompanying context for the one or more actions taken via different portions of a user interface.
